(19) United States
(12) Patent Application Publication
(10) Pub. No.: US 2007/0081647 A1
(43) Pub. Date: Apr. 12, 2007

(54) Conference bridge alert method and system

(75) Inventor: Thomas W. Baker, Orefield, PA (US)

Correspondence Address: DUANE MORRIS, LLP;IP DEPARTMENT, 30 SOUTH 17TH STREET, PHILADELPHIA, PA, 19103-4196, US

(73) Assignee: Agere Systems Inc.

(21) Appl. No.: 11/238,317

(22) Filed: Sep. 29, 2005

(51) Int. Cl. H04M 1/00

(52) U.S. Cl. 379/158

(57) ABSTRACT

A method for call conferencing is provided. An event is detected when a caller is unable to join an established conference call, because a maximum number of conference participants associated with a conference bridge used for the conference call are currently participating in the conference call. A first audio message is played to the conference participants in response to the detected event.

### FIELD OF THE INVENTION

The present invention relates to telephone conference bridge systems, and methods of using the conference bridge systems.

### BACKGROUND

Conference call bridges that can support many participants have become very popular and are used extensively. Such a bridge is connected to a telecommunications switch and can support a plurality of incoming telephone calls. A conference bridge allows many participants to independently dial in to a pre-determined telephone number at a pre-arranged time. Typically, an automated attendant allows only authorized participants by intercepting each caller attempting to join the conference call and obtaining information from each caller to validate that the caller is authorized to participate in the conference call. For example, after dialing the predetermined telephone number to reach the conference bridge, participants typically enter a conference code associated with a specific conference.

A conference bridge typically has a maximum number of users. Once the number *of participants in a conference call reaches the maximum number, no more callers can join the conference until at least one participant exits the conference call. Often, a bridge becomes full and a caller cannot enter the bridge, regardless of whether the caller is a necessary or highly important participant. The caller receives a busy signal.

FIG. 3 is a flow chart diagram of a conventional method of handling a full-bridge condition.

At step 300, the conference bridge detects that a caller is attempting to join the conference.

At step 302, the conference bridge determines whether the bridge is full (i.e., whether the maximum number of users are already participating in the conference call. If the bridge is full, step 304 is executed. If the bridge is not full, step 308 is executed.

At step 303, if the bridge is not full, the caller is added to the bridge as another participant, and the number of additional participants that can be added by the bridge is reduced by one.

At step 304, if the bridge is full, the bridge plays an automated “bridge full” message informing the caller that the bridge is full (i.e., that the maximum number of participants are already connected on the conference call).

At step 306, the caller is disconnected, and the caller's session ends.

In the event that a caller is unable to join the conference call because the conference bridge is full, the caller has limited options available for contacting the current participants while the call is still in session. For example, the caller can send an email message to one or more participants; however, the participants do not necessarily check their email while participating in the conference, and may not see the email message until after the conference has ended. The caller may try to contact a participant by the participant's mobile telephone (because the participants' land lines are already connected to the teleconference); however, the participants' mobile telephone numbers may be unknown to the caller. Even if the caller knows the mobile telephone number of a participant, the participant's mobile telephone may not work if the participant is indoors, and the participant's mobile telephone will be busy if the participant is already using it to connect to the conference bridge.

U.S. Patent Application Publication No. 2005/0069116 describes a call conferencing apparatus, method, and computer program to detect one or more events that are related to a conference call. The program sends one or more instant messages to one or more participants associated with the conference call. The one or more events could include, for example, a participant joining the conference call, a participant exiting the conference call, a participant failing to log into the conference call correctly, a participant transferring to another communication device during the conference call, a beginning of the conference call, and an end of the conference call. However, the instant messages have shortcomings similar to the use of manually generated emails discussed above. The participants are not necessarily looking at their computers while participating in the conference, and may not see the instant message until after the conference has ended.

### SUMMARY OF THE INVENTION

A method, system and computer readable medium encoded with computer program code for call conferencing include detecting an event wherein a caller is unable to join an established conference call, because a maximum number of conference participants associated with a conference bridge used for the conference call are currently participating in the conference call. A first audio message is played to the conference participants in response to the detected event.

### BRIEF DESCRIPTION OF THE DRAWINGS

FIG. 1 is a block diagram of an exemplary system in which an embodiment of the invention is practiced.

FIG. 2 is a block diagram of the conference bridge shown in FIG. 1.

FIG. 3 is a flow chart diagram showing a prior art conference call method.

FIG. 4 is a flow chart diagram showing a conference call method according to an embodiment of the invention.

### DETAILED DESCRIPTION

This description of the exemplary embodiments is intended to be read in connection with the accompanying drawings, which are to be considered part of the entire written description.

Examples are described below in which a conference bridge 20 detects an event wherein a caller is unable to join an established conference call because a maximum number of conference participants associated with the conference bridge are currently participating in the conference call. The conference bridge plays a first audio message to the conference participants in response to the detected event. In some embodiments, the conference bridge enables the caller to record an audio clip that is played for the participants in the conference call as a part of the first message.

The first audio message may optionally provide contact information to the current participants to allow them to contact the caller via other means outside of the conference bridge. Alternatively, the first audio message may optionally request that a participant disconnect from the conference so that the caller can join the conference. Alternatively, the first audio messgae may include any information that the caller needs to convey to the participants, to enable them to complete the business of the conference call without the caller. These are only examples of the types of information that can be included in the first message, and do not limit the content of the first message, or the uses for which the participants employ the information they receive in the first audio message.

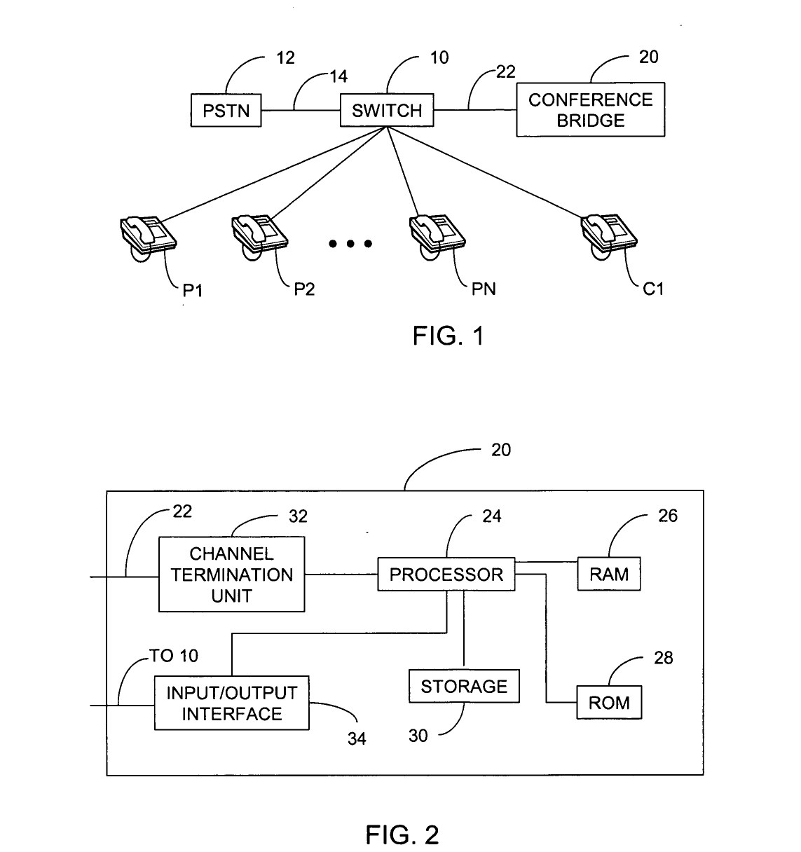

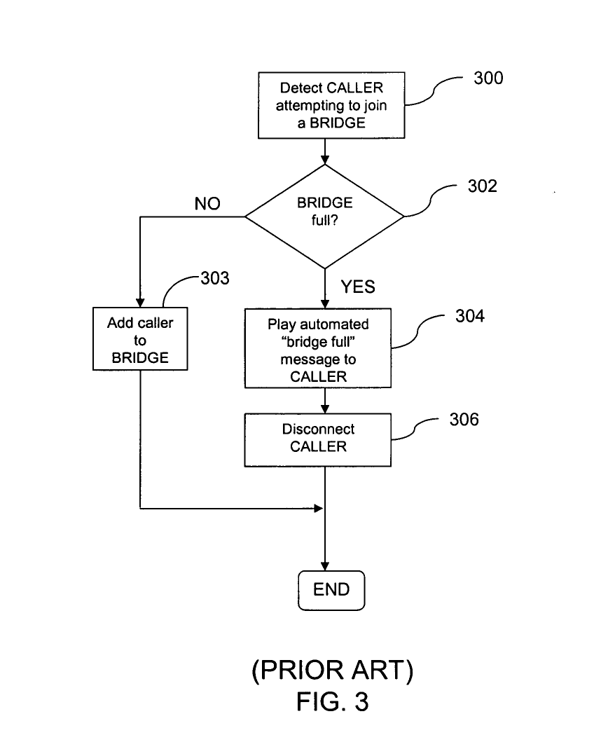

FIG. 1 is a block diagram of an exemplary system in which an embodiment of the invention is practiced. The system includes a telecommunications switch 10, e.g. a class five switch, that is connected to the public switched telephone network (PSTN) 12 by one or more communication channels 14. Exemplary telephone sets P1, P2, . . . , PN (used by current participants in the conference call) and telephone set C1 (used by an incoming caller) are connected to the switch 10 via wired and/or wireless links. A conference bridge 20 is connected to switch 10 by a communication channel 22. Depending on the number of participants that can be simultaneously terminated by the conference bridge 20, the channel 22 may include a plurality of telephone lines that each carry only one call or may include one or more trunk lines each capable of carrying a plurality of simultaneous telephone calls.

FIG. 2 is a block diagram of an exemplary conference bridge 20 in accordance with an exemplary embodiment. A processor 24, e.g. a microprocessor, is coupled to random access memory (RAM) 26, read-only memory (ROM) 28, and a nonvolatile storage device 30 such as a disk drive, flash memory drive or the like. A channel termination unit 32 operates under the control of processor 24 and terminates incoming calls over the channel 22. In addition to being able to terminate incoming calls, channel termination unit 32 can conference or combine incoming calls to form one or more conference calls based on directions provided by processor 24. An input/output interface 34 is coupled to processor 24 and enables the conference bridge 20 to receive and transmit command and control signals from and to switch 10. The processor 24 executes stored program control instructions in storage device 30, and enables the conference bridge 20 to provide call conferencing functions.

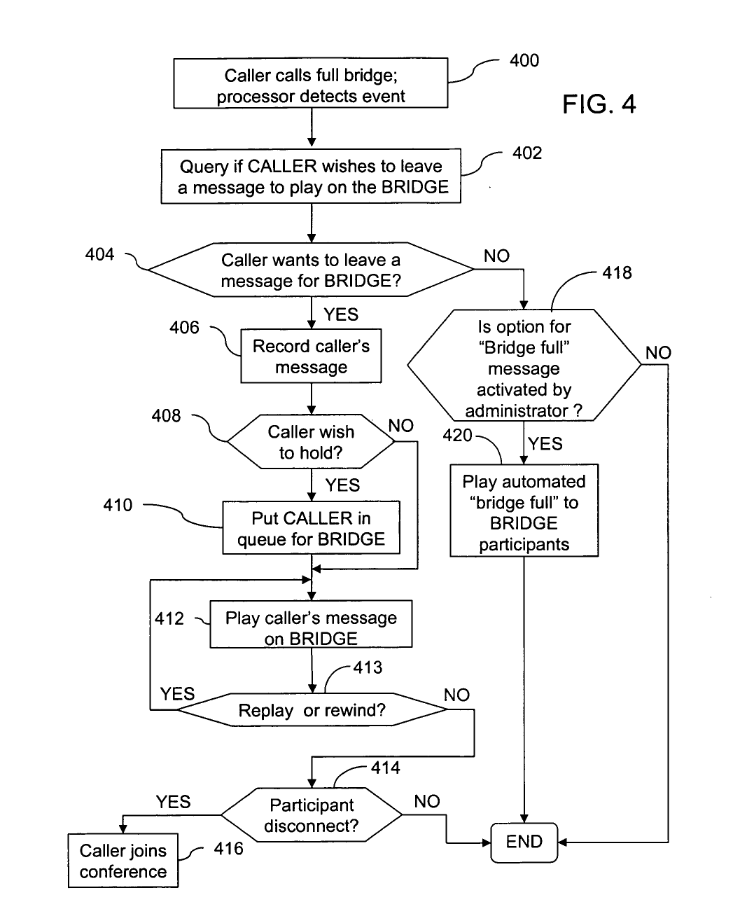

FIG. 4 is a flow chart diagram showing an exemplary method according to one embodiment. FIG. 4 is focused on the steps performed when a caller (using telephone C1) reaches a full conference bridge 20 that cannot add another participant. For purpose of FIG. 4, it does not matter whether the bridge 20 cannot add another participant because the current number of participants equals the maximum hardware-imposed limit that the bridge 20 can accommodate, or because the current number of participants equals a software controlled limit set by a system administrator.

The step of adding the caller to a conference call that is not full can be the same as described above for a prior art conference bridge, and is not shown in FIG. 4 or discussed further below.

At step 400, the caller calls a full conference bridge 20 using the telephone C1. The processor 24 detects the event wherein the caller is unable to join the established conference call because a maximum number of conference participants associated with the conference bridge 20 used for the conference call are currently participating in the conference call. The system performs the steps described in FIG. 4 (or equivalent steps) in either case.

At step 402, the processor 24 causes the conference bridge to play a message telling the caller that the bridge is full and inviting the caller to record an audio clip that is to be included in a first audio message to be played for the participants of the conference call.

At step 404, the caller provides a response to the conference bridge 20 indicating whether the caller wants to leave a message (audio clip) for the participants currently using the bridge. For example, the caller may use the telephone C1 to generate a DTMF tone, or the conference bridge may allow the caller to respond by voice, after which the bridge decodes the caller's response using speech recognition. If the caller indicates that he or she wants to record a message (audio clip), step 406 is executed. If the caller indicates that he or she does not want to record a message, step 418 is executed.

At step 406, the caller records the audio clip. Preferably, the caller provides contact information, including at least one of the group consisting of an identification of the caller or an identification of a telephone number from which the caller is calling, or a pager number, email address, phone number, instant message handle, website, facsimile number, a text message address of the caller, or the like.

In some embodiments, the conference bridge prompts the caller to record a first audio clip including the caller's name and/or contact information, and then prompts the caller to record a second audio clip containing a free-form message including content of the caller's choosing.

At step 408, the conference bridge invites the caller to wait “on hold,” to see whether one of the current participants can disconnect from the conference call, so that the conference bridge can allow the caller to join the conference call. The caller can respond to the conference bridge 20 via DTMF tone or by speech, which the bridge recognizes using speech recognition. If the caller wishes to wait on hold, then step 410 is executed next. If the caller does not wish to wait, then step 410 is skipped, and step 412 is executed next.

At step 410, if the caller has chosen to wait on hold, the caller is placed in a queue. The caller can then wait for one of the current participants to disconnect from the bridge.

At step 412, a first audio message is played to the conference participants in response to the detected event. In some embodiments, the first audio message may simply be an indication that a caller has tried to join the conference, but was unable to do so, because the maximum number of participants are already on the conference call. Optionally, in embodiments that allow the caller to record a first audio clip containing the caller's name, the first message includes the caller's name.

In some embodiments, the audio clip(s) recorded by the caller include contact information which is played for the participants.

In some embodiments, in which the caller has been invited to wait on hold, and the caller has indicated that he or she wants to wait on hold, a pre-recorded system message requests that one of the current participants disconnect from the call, so the caller can join the call. This may be convenient, for example, where at least two of the current participants are located in the same building and can share a single speaker telephone. In some embodiments, the caller's audio clip may contain the request for one of the current participants to disconnect from the call. The participants can quickly decide whether it is convenient for one of them to disconnect from the conference call, without impairing the ability of the remaining participants to complete the business being conducted.

At step 413, in some embodiments, the conference participants are given the option to replay the audio clip recorded by the caller. The participants can choose the replay option by a providing a DTMF tone (by pressing a key no the telephone keypad). In some embodiments, the entire audio clip is replayed. In other embodiments, providing a DTMF tone rewinds the audio clip by a short predetermined period (e.g., 10 seconds). Alternatively, the participants may have a choice of providing two different DTMF tones, to replay the entire audio clip or rewind the audio clip by the predetermined period.

If the participants choose to replay or rewind the audio clip at step 413, the audio clip is replayed or rewound, and step 412 is again executed. At the conclusion of the audio clip, the participants can replay or rewind as many times as they desire. When the participants no longer wish to replay or rewind, step 414 is executed.

At step 414, the system detects if one of the participants disconnects from the bridge. If a participant disconnects, then step 416 is executed. In some embodiments, if no participant disconnects within a predetermined period of time, the conference bridge may play a message to the caller, suggesting that the caller try to call in again later. In other embodiments, if no participant disconnects, the bridge 20 takes no further action with respect to the caller. In either case, the current participants have been provided with information that they can use to contact the caller offline, or with information (via the caller's audio clip) or materials (e.g., via email to which the caller alerted them via the audio clip) that they can use to complete the business of the teleconference.

At step 416, if one or more of the participants have disconnected from the bridge, then the caller is permitted to join the conference, and the conference then proceeds to its normal conclusion.

Step 418 is executed when the caller indicates that he or she does not wish to leave a message to be played for the participants. For example, the caller may not consider himself or herself to be an important player in the conference, and may choose not to interrupt the conference. At step 418, the system checks whether the system administrator has activated a default, “Bridge full” message to be played to the participants when the bridge is full, and a caller who is denied entry to the conference declines to leave a message. If the option is activated, step 420 is executed. If the option is not activated, then the bridge 20 takes no further action in response to the “bridge full” event, and the conference continues to its normal conclusion. The administrator may choose not to activate this option in order to suppress playing of the first audio message if the caller does not record the audio clip, to minimize interruptions. For example, in a large conference call expected to include a hundred participants, where dozens more may be closed out from joining the conference, the administrator may choose to disable the default message, so that the conference is only interrupted when the caller leaves a message for the participants.

At step 420, if the “bridge fall” default message option is activated, the bridge 20 plays a pre-recorded audio clip to the participants. In some embodiments, the pre-recorded audio clip merely indicates that a caller is unable to join the conference because the maximum number of conference participants are currently participating in the conference call, and (optionally) an indication that the caller did not record an audio clip. In other embodiments, the caller's telephone number (obtained automatically from the caller ID signal of the caller) is included with the pre-recorded default message.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, ZIP™ disks, flash memories, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for call conferencing, comprising:
detecting an event wherein a caller is unable to join an established conference call because a maximum number of conference participants associated with a conference bridge used for the conference call are currently participating in the conference call; and
playing a first audio message to the conference participants in response to the detected event.

2. The method of claim 1, wherein the first audio message includes a pre-recorded audio clip indicating that the caller is unable to join the conference because the maximum number of conference participants are currently participating in the conference call.

3. The method of claim 2, wherein the first audio message further includes contact information of the caller.

4. The method of claim 3, wherein the contact information includes at least one of the group consisting of an identification of the caller or an identification of a telephone number from which the caller is calling or a pager number, email address, phone number, instant message handle, website, facsimile number, or text message address of the caller.

5. The method of claim 2, wherein the first audio message includes a request for at least one of the participants to exit the conference call, the method further comprising:
enabling the caller to join the conference call after one of the participants exits the conference call.

6. The method of claim 5, further comprising:
playing a second audio message inviting the caller to wait on the line while the first audio message is played for the current participants.

7. The method of claim 1, further comprising:
inviting the caller to record an audio clip that is to be included in the first audio message.

8. The method of claim 7, further comprising:
recording the audio clip; and
playing the audio clip in the conference call.

9. The method of claim 8, further comprising the step of enabling one of the conference participants to replay or rewind the audio clip.

10. The method of claim 7, wherein the first audio message includes an indication that the caller did not record an audio clip.

11. The method of claim 7, further comprising enabling an administrator of the conference bridge to suppress playing of the first audio message if the caller does not record the audio clip.

12. In a system for call conferencing, the improvement comprising:
a processor that detects an event wherein a caller is unable to join an established conference call because a maximum number of conference participants associated with a conference bridge used for the conference call are currently participating in the conference call;
said processor playing a first audio message to the conference participants in response to the detected event.

13. The system of claim 12, wherein:
the first audio message includes: contact information of the caller, and a request for at least one of the participants to exit the conference call, and
the processor enables the caller to join the conference call after one of the participants exits the conference call.

14. The system of claim 13, wherein the processor plays a second audio message inviting the caller to wait on the line while the first audio message is played for the current participants.

15. The system of claim 12, wherein:
the processor plays a recording inviting the caller to record an audio clip that is to be included in the first audio message
the processor records the audio clip; and
the processor plays the audio clip in the conference call.

16. The system of claim 15, wherein:
the processor enables one of the conference participants to replay or rewind the audio clip.

17. A computer readable medium encoded with computer program code, such that, when the computer program code is executed by a processor, the processor performs a method for call conferencing, comprising:
detecting an event wherein a caller is unable to join an established conference call because a maximum number of conference participants associated with a conference bridge used for the conference call are currently participating in the conference call; and
playing a first audio message to the conference participants in response to the detected event.

18. The computer readable medium of claim 17, wherein the first audio message includes a request for at least one of the participants to exit the conference call, the method further comprising:
enabling the caller to join the conference call after one of the participants exits the conference call.

19. The computer readable medium of claim 18, wherein the method performed by the processor further comprises:
playing a second audio message inviting the caller to wait on the line while the first audio message is played for the current participants.

20. The computer readable medium of claim 17, wherein the method performed by the processor further comprises:
inviting the caller to record an audio clip that is to be included in the first audio message;
recording the audio clip; and
playing the audio clip in the conference call.
